(19) United States
(12) Patent Application Publication
(10) Pub. No.: US 2026/0158722 A1
(43) Pub. Date: Jun. 11, 2026

(54) Temperature control device for a plasticizing screw and/or a plasticizing cylinder of a plasticizing unit

(71) Applicant: Sebastian PÜTTER, Lennestadt - Kirchveischede (DE)

(72) Inventor: Sebastian PÜTTER, Lennestadt - Kirchveischede (DE)

(21) Appl. No.: 18/708,055

(22) PCT Filed: Nov. 4, 2022
(86) PCT No.: PCT/DE2022/100814

§ 371 Date: May 7, 2024

(30) Foreign Application Priority Data
Nov. 8, 2021 (DE) 10 2021 129 015.5

(51) Int. Cl. B29C 45/78; B29C 35/02; B29C 45/47; B29C 45/74; B29C 48/505; B29C 48/84; B29C 48/92

(52) U.S. Cl. CPC B29C 45/78; B29C 35/02; B29C 45/47; B29C 45/74; B29C 48/507; B29C 48/845; B29C 48/92; B29C 2035/0211; B29C 2945/76531; B29C 2945/76665; B29C 2948/92704; B29C 2948/92885; B29K 2995/0005; B29K 2995/0006

(57) ABSTRACT

A temperature control device (10) for a plasticising screw (1′) and/or a plasticising cylinder (1″) of a plasticising unit is presented. The plasticising screw (1′) and/or the plasticising cylinder (1′) is formed from a hollow cylinder (11), in the central longitudinal cavity (110) of which the temperature control device (10) for controlling the temperature of the plasticising screw (1′) and/or of the plasticising cylinder (1″) is accommodated. The temperature control device (10) is characterised in that it (10) is in the form of an inner cylinder (100) which is designed to be accommodated in the hollow cylinder (11), and on the outer lateral surface (1000) of which at least one flat heating element (101) is arranged or applied.

### CROSS-REFERENCE TO RELATED APPLICATION

This application is a national stage application, filed under 35 U.S.C. § 371, of International Patent Application PCT/DE 2022/100814, filed on Nov. 4, 2022, which claims the benefit of German Patent Application DE 10 2021 129 015.5, filed on Nov. 8, 2021.

### TECHNICAL FIELD

The present disclosure relates to a plasticizing screw and/or a plasticizing cylinder with a temperature control device.

### BACKGROUND

According to the current state of the art, a plasticizing cylinder of an injection molding or extrusion machine consists of a one-piece component. This is a cylinder tube made of steel, which can be made of different material grades depending on the material to be processed and the wear requirements. The designs range from hardened steels and nitriding steels up to centrifugally cast bimetal cylinders for processing particularly abrasive plastic materials. Conventional heating of the plasticizing cylinder is thereby effected by means of ceramic heating tapes which are clamped around the plasticizing cylinder in a force-fitting manner (see also DE102012112747A1).

In another technical solution, so-called “heating coils” are used instead of ceramic heating tapes. For this purpose, the plasticizing cylinder has labyrinth-like grooves along its length in which square heating coils are inserted. Thereby, the advantage of this solution is that the heater is positioned closer to the melt channel, which means that the process temperature is reached more rapidly. The larger contact surface of the heating coil is advantageous here, since it not only has a contact surface on the cylinder diameter, but also has two lateral contact surfaces to the plasticizing cylinder due to the integrated installation in the plasticizing cylinder (see also DE102018112939A1).

WO2010056281A1 describes a further solution for heating plasticizing cylinders. The plasticizing cylinder is coated with a plasma-sprayed, metallized ceramic surface and therefore can be heated electrically.

Internet reports also reveal solutions that use gas heating by means of natural gas ring elements instead of electrical heating (see, for example, Krauss-Maffei Kunststofftechnik GmbH, Munich)—a patent for this could not be found.

In the case of crosslinkable plastics, liquid temperature control (bores in the plasticizing cylinder and, if necessary, the use of heat-conducting cartridges or tube coils around the plasticizing cylinder) is used-these are described, for example, in DE3139024A1 or DE202014005708U1.

While a one-piece structure made of solid steel and without heating options has so far been chosen for plasticizing screws in injection molding, application-specific internally heated plasticizing screws are used in the extrusion sector. The plasticizing screw is heated by internal heat-conducting tubes or helical bodies as described, for example, in patent DE10013474A1.

The main disadvantage of the known solutions is the poor efficiency of the system. This results in a high heat transfer torque due to the external heating and the thick-walled plasticizing cylinder. Temperature control can only be very slow and reacts too slowly to system drifts. Such inertia also arises when heating the plasticizing cylinder, since the mass (wall thickness) of the cylinder must initially be heated through. The outer assembly of the heating elements also means that a considerable amount of waste heat is radiated into the environment and does not reach the inside of the plasticizing cylinder as desired. The segmented arrangement of the outer heating elements leads to thermal bridges and thus to inhomogeneous heat distribution-due to the design, it is not possible to achieve uninterrupted contact between two heating elements.

In the event of an accident, leaks occur between the plasticizing cylinder nozzle and the injection mold nozzle. These leaks result in overspray of the outer heating tapes by molten plastic material-in these cases, the only option is to replace the heating tapes.

Processing disadvantages arise from the fact that the melting of the plastic granulate only takes place from the outside (the plastic granulate melts on the inner wall of the cylinder) and therefore requires longer melting times. In order to reduce this melting time, a higher back pressure and a more rapid screw speed are often used however, these two parameters also result in higher wear on the screw drive unit and a higher required drive power=power consumption. In addition, temperatures above the permissible processing temperature are also selected to achieve the shortest possible melting times. However, the higher melt temperature due to the above points also means a higher article temperature, which rarely enables damage-free demolding. For this reason, the finished part must undergo a longer cooling time before demolding, thus extending the cycle time.

Material and color changes often result in deposits on the non-tempered plasticizing screw, which then require a complex cleaning process using chemical or physical cleaners to loosen the deposits on the colder plasticizing screw.

### SUMMARY

An improved plasticizing screw eliminates the aforementioned disadvantages. The plasticizing screw includes a hollow cylinder having helical flights arranged on an outer surface thereof and a central cavity, A temperature control device is arranged in the central cavity. The temperature control device includes an inner cylinder, and a flat heating element arranged or applied to an outer lateral surface of the inner cylinder.

Further goals, features, advantages and possible applications of the plasticizing screw and a temperature control device are shown in the following description of exemplary embodiments with reference to the drawings.

### BRIEF DESCRIPTION OF THE DRAWINGS

FIG. 1 shows a view of a temperature control device;

FIG. 2 shows a perspective view of the temperature control device;

FIG. 3 shows a side view of the temperature control device;

FIG. 4 shows a side view of the temperature control device in a further, embodiment.

### DETAILED DESCRIPTION

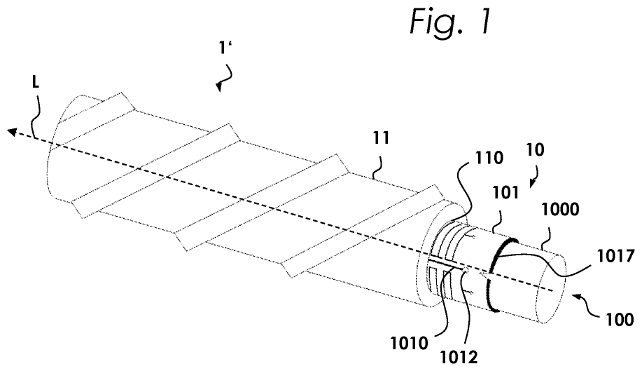

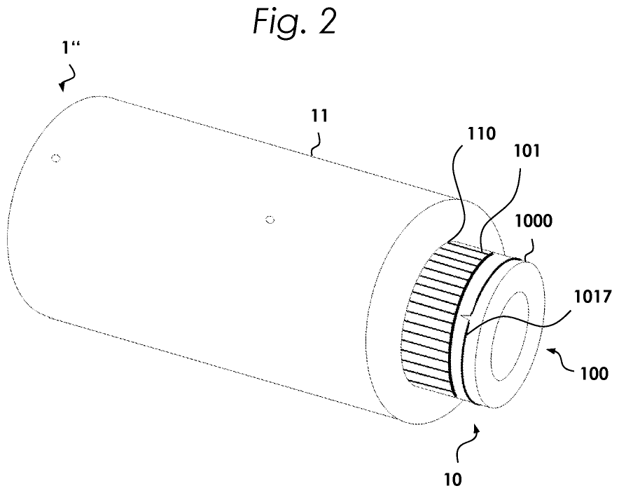

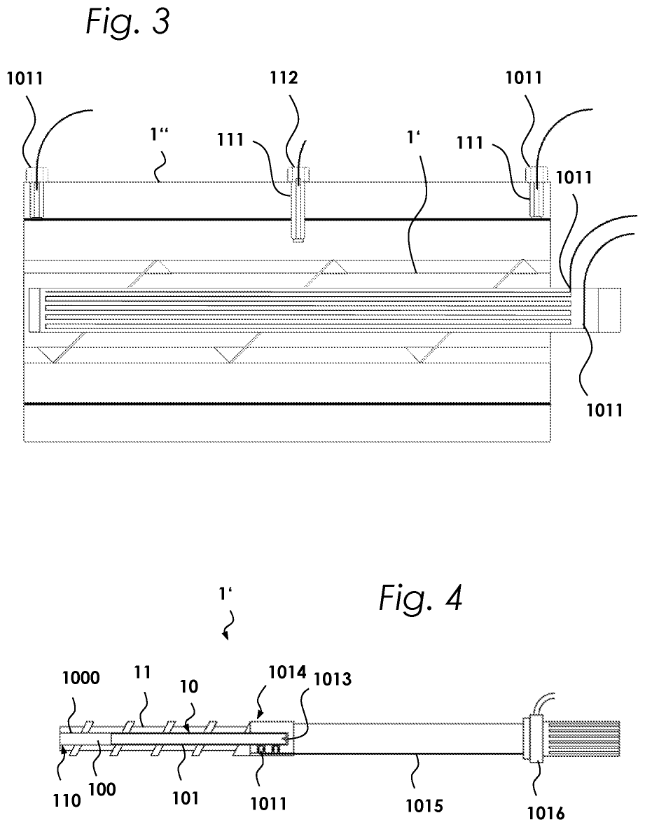

As can be seen from FIG. 1, a plasticizing screw 1′ and/or a plasticizing cylinder 1″ of a temperature control device 10 is formed from a hollow cylinder 11, in the central longitudinal cavity 110 of which the temperature control device 10 for controlling the temperature of the plasticizing screw 1′ and/or the plasticizing cylinder 1″ is accommodated.

The temperature control device 10 is characterized in that it is formed from an inner cylinder 100 for accommodation in the hollow cylinder 11, on the outer surface 1000 of which at least one flat heating element 101 is applied.

In a particularly advantageous embodiment, the at least one flat heating element 101 comprises at least one electrical resistance heating conductor for converting electrical energy into heat with at least two electrical terminals that can be contacted in a terminal region.

The at least one planar heating element 101 is thereby preferably designed as a thick-film heater, wherein it is particularly advantageous that a dielectric layer is applied to the lateral surface 1000 of the inner cylinder 100.

Due to their minimal installation height and high power density, thick-film heaters can be positioned close to the melt. For this purpose, the plasticizing cylinder 1″ preferably consists of an outer hollow cylinder 11 and an inner cylinder 100 along with a preferably sleeve-shaped heating element 101, preferably a steel or ceramic sleeve 1017, which can be arranged on or applied to the outer lateral surface 1000 of the inner cylinder 100 and on which a thick-film heater has been printed by means of a screen printing method and fired by subsequent sintering processes. The hollow cylinder 11 and the inner cylinder 100 are thereby preferably secured against axial rotation so that they do not rotate during the dosing movement of the screw and melt.

In a particularly advantageous embodiment, if the heating element 101 is an electrically conductive material, a full-surface dielectric layer is initially applied to the lateral surface of the heating element 101. Subsequently, screen printing of a preferably meandering heating structure onto the heating element 101 is effected. The contacting of the heating structure is effected via the start point and end point of the printed resistance heater. Finally, a second full-surface dielectric layer/cover layer is printed on for renewed insulation and protection against mechanical effects. To ensure the positional accuracy of the different print layers, the heating element 101 preferably has a small alignment notch on one end face, which facilitates easy adjustment in the rotary screen printing machine.

The inner diameter of the heating element 101 with thick-film heating thereby advantageously corresponds to the precisely fitting outer diameter of the inner cylinder 100, such that this can be pushed on at room temperature in a positive-locking manner.

The inner cylinder 100 thereby preferably has a collar on one side that corresponds to the outer diameter of the heating element 101. This ensures the correct position of the heating element 101 and represents a stop for this purpose. In order to prevent the heating element 101 from slipping, an end cap with the outer diameter of the heating element 101 is preferably screwed onto the other end of the inner cylinder 100 after the assembly of the heating element 101—the heating element 101 is thus positioned between a collar of the inner cylinder 100, an end cap and the outer diameter of the inner cylinder 100 in a positive-locking manner. The heating element 101 mounted on the inner cylinder 100 is now inserted into the hollow cylinder 11 in a positive-locking manner at room temperature.

For this purpose, the outer hollow cylinder 11 preferably has a screwed-on end cap for securing the inner cylinder 100 in the correct position with the heating element 101. Furthermore, the hollow cylinder 11 of the plasticizing cylinder 1″ can preferably be provided with receptacles and/or bores 111 for accommodating temperature sensors 112 for controlling the heating power of the planar heating element 101 and/or for contacting the planar heating element 101.

A tongue-and-groove principle between the end caps of the hollow cylinder 11 in interaction with the inner cylinder 100 and hollow cylinder 11 effects a radial alignment of the cylinders 11, 100, such that the receptacles and/or bores 111 for the temperature sensors 112 and terminals 1011/contacts are positioned correctly one above the other and the two cylinders 11, 100 cannot rotate relative to one another during the dosing process.

In order to achieve a full-surface and force-fit contact of the heating element 101 in the heated state, the inner cylinder 100 and the hollow cylinder along with the heating element 101 preferably consist of materials with different coefficients of thermal expansion. Thereby, the inner cylinder 100 advantageously has a greater coefficient of thermal expansion than the outer sleeve; the heating element 101 thereby preferably has a higher coefficient of thermal expansion than the inner cylinder 100.

An insulation made of aerogel, which not only prevents heat loss but also enhances worker safety by reducing the risk of burns, is seated on the hollow cylinder 11. Thereby, the outer insulation can be protected from possible overspray by a stainless steel casing.

The plasticizing screw 1′ in accordance with FIG. 1 is preferably hollow on the inside and thus offers the possibility of accommodating a cylindrical temperature control device 10. This temperature control device 10 preferably consists of a thermally conductive rod 100 and a sleeve 1017 made of steel or ceramic. If the sleeve 1017 is an electrically conductive material, a full-surface dielectric layer is initially applied to the lateral surface of the sleeve 1017. Subsequently, the screen printing of a preferably meandering heating structure of the heating element 101 onto the sleeve 1017 is effected. The contacting of the heating element 101 is effected via the start point and end point of the printed resistance heater at an end face of the sleeve 1017.

Finally, a second full-surface dielectric layer/cover layer is printed on for renewed insulation and protection against mechanical effects. To ensure the positional accuracy of the individual print layers, the sleeve 1017 has a small alignment notch on one end face in order to make it easier to adjust in the rotary screen printing machine. The inner diameter of the sleeve 1017 with thick-film heating thereby corresponds to the precisely fitting outer diameter of the rod 100, such that this can be pushed on at room temperature in a positive-locking manner. The rod 100 thereby has a collar on one side that corresponds to the inside diameter of the plasticizing screw 1′. This ensures the correct position of the sleeve 1017 and represents a stop for this purpose. To prevent the sleeve 1017 from slipping, it is secured at the other end of the rod with a locking pin 1013. The sleeve 1017 is thus positioned in a positive-locking manner between a collar of the rod, a locking pin and the outer diameter of the rod 100. The sleeve 1017 mounted on the rod 100 is now pushed in a positive-locking manner into the plasticizing screw 1′ up to a defined stop at room temperature. The correct and secure position of the assembled sleeve with thick-film heater on the rod material is secured within the plasticizing screw by a grub screw or screwed-in screw tip. In order to achieve a full-surface and force-fit contact of the sleeve 1017 in the heated state, the rod 100 and the plasticizing screw 1′ along with the sleeve 1017 consist of materials with different coefficients of thermal expansion. Thereby, the rod 100 preferably has a greater coefficient of thermal expansion than the plasticizing screw 1′. Thereby, the sleeve 1017 preferably has a higher coefficient of thermal expansion than the rod 100. A longitudinal recess or cutout 1010 (preferably a slot) preferably extends over at least 75% of the length of the sleeve 1017 and supports the thermal expansion behavior. The opening 1012 (for example, a bore) at the end of the longitudinal slot prevents the sleeve 1017 from tearing completely through/open under thermomechanical load. The electrical terminal of the heating element 101 is preferably effected via two bores in the spiral die 1014 of the plasticizing screw 1′, wherein a spring contact with electrical insulation (to the plasticizing screw) is screwed into each of these two bores. These bores/screwed-in spring contacts are thereby seated in the correct position over the contacting points of the heating element and thus provide an electrical connection via the spring-loaded contact. A sliding contact/rotating contact for feeding the electrical power to the heating element is seated at the drive-side end of the plasticizing screw. The connection between the rotating part of the slip ring 1016 and the spring contacts in the spiral die of the plasticizing screw is thereby effected by means of heat-resistant electrical cables 1015. The heat-resistant electrical cables 1015 are thereby preferably located in a groove in the longitudinal direction of the plasticizing screw 1′ that protects them from external influences. The temperature control of the plasticizing screw is effected by receiving and regulating the resistance changes of the heater and therefore does not require a separate temperature sensor. The region of the contacting solution described above is thereby protected by a dust-repellent, water-repellent and dirt-repellent housing and/or potting compound and also provides electrical protection from the outside.

The present disclosure further comprises a plasticizing screw 1′ and also a plasticizing cylinder 1″, which are formed (equipped) with a temperature control device 10.

The main advantage of the disclosed design lies in the increased efficiency of the heater. Due to the positioning of the heating elements in the plasticizing cylinder and the plasticizing screw close to the melt channel, the system can be heated up much more rapidly and therefore results in less downtime when restarting after an interruption in production. In addition, the position of the heating elements allows a rapid reaction to system drifts, for example in the form of minor temperature fluctuations in the case of batch fluctuations in the plastic granulate.

Thanks to the full-surface application of the thick-film heating, there are also no thermal bridges between individual heating zones-this prevents possible process fluctuations due to inhomogeneous heat distribution. Homogeneous melting is achieved by the already proven external heating by means of the plasticizing cylinder and the innovative internal heating by the plasticizing screw 1′.

By the technical solution of the internally heated plasticizing screw 1′, almost 100% of the heating energy introduced reaches the plastic granulate. A thermal equilibrium in the cross-section of the melt channel is achieved by melting the plastic granulate from the outside and inside. This reduces the risk of unmelted plastic pellets and subsequent surface defects on the finished part. Since the area of the heating energy input is increased, the plastic granulate no longer has to be melted at the top processing temperature and possibly above. In order to achieve the shortest plasticizing times and thus cycle times, this has been common practice to date and is detrimental to the material properties—under certain circumstances thermal degradation of the material occurs.

Since the processing temperatures can be lowered due to the more rapid and more homogeneous heat input, a shorter cooling time and more rapid reaching of the demolding temperature of the finished part is possible, which in turn leads to more rapid cycle times and increased output.

The homogeneous heat input leads to the screw speed and the back pressure of the machine being able to be reduced. The value of these two parameters has an influence on the frictional heat input into the plastic melt, among other things.

In order to compensate for a lack of heating power of the cylinder heating and to achieve a more homogeneous plastic melt, these parameters are generally selected higher in conventionally heated systems. However, a higher screw speed as well as a higher dynamic pressure have a negative effect on the wear of the plasticizing screw drive unit and the energy requirement.

If color and/or material changes are required on the machine, chemical or physical screw cleaners are used to clean the system. These achieve a cleaning effect on the screw by chemical reaction or abrasive action and loosen existing deposits from previous production. By using the heated plasticizing screw 1′, such cleaners can be dispensed with in the future, since the deposits can be loosened by increasing the temperature of the plasticizing screw.

The insulation made of aerogel keeps the energy/temperature introduced in the system of the plasticizing unit and reduces not only the energy input, but above all the previously known waste heat losses. Due to this fact, air conditioning in the production hall/the production environment may no longer be necessary for process-stable production. Work safety is also improved by reducing the surface temperature on the plasticizing cylinder.

An encapsulated structure by means of a stainless steel sheet casing protects the underlying insulation from possible overspraying and makes it unnecessary to replace the insulation and other functional elements (for example, temperature sensor and contacting) in the event of an accident.

If there is a defect in the heating elements, they can be replaced separately from the plasticizing cylinder 1″ and the plasticizing screw 1′—existing plasticizing systems can be retrofitted by reworking.

Due to the more effective melting of the plastic granulate, it is conceivable that the plasticizing unit can be shortened and therefore requires less material (steel) and production space to set up the machine.

### LIST OF REFERENCE SIGNS

1′ Plasticizing screw
1″ Plasticizing cylinder
10 Temperature control device
11 Hollow cylinder
100 Inner cylinder of the temperature control device
101 Heating element
110 Longitudinal cavity of the hollow cylinder
111 Receptacles and/or bores
112 Temperature sensors
1000 Lateral surface of the inner cylinder
1010 Recess or cut-out
1011 Electrical terminals
1012 Opening
1013 Locking pin
1014 Vortex outlet
1015 Electrical cables
1016 Slip ring
1017 Sleeve
L Longitudinal direction

1-13. (canceled)

14. A plasticizing screw (1′), comprising:
a hollow cylinder (11) having helical flights arranged on an outer surface thereof and a central cavity (110); and
a temperature control device (10) arranged in the central cavity (110), the temperature control device (10) including
an inner cylinder (100), and
a flat heating element (101) arranged or applied to an outer lateral surface (1000) of the inner cylinder (100).

15. The plasticizing screw (1′) according to claim 14,
wherein the flat heating element (101) comprises an electrical resistance heating conductor for converting electrical energy into heat with at least two electrical terminals (1011), and
wherein the electrical terminals (1011) can be contacted in a terminal region.

16. The plasticizing screw (1′) according to claim 14,
wherein the flat heating element (101) is a thick-film heater.

17. The plasticizing screw (1′) according to claim 14,
wherein the flat heating element (101) is a sleeve (1017) arranged on or applied to the outer lateral surface (1000) of the inner cylinder.

18. The plasticizing screw (1′) according to claim 15,
wherein the electric resistance heating conductor is an electrical resistance paste that has been printed on the inner cylinder (100) or the heating element (101).

19. The plasticizing screw (1′) according to claim 14, further comprising
a dielectric layer applied to the outer lateral surface (1000) of the inner cylinder (100).

20. The plasticizing screw (1′) according to claim 14, further comprising
a recess or a cut-out (1010) extending in a longitudinal direction (L) of the flat heating element (101).

21. The plasticizing screw (1′) according to claim 20,
wherein the recess or the cut-out (1010) extends over at least 75% of a length of the heating element (101).

22. The plasticizing screw (1′) according to claim 20,
wherein the recess or the cut-out (1010) is slot-shaped.

23. The plasticizing screw (1′) according to claim 20,
wherein an opening (1012) is formed at an end of the recess or the cut-out (1010) on the heating element (101), and
wherein a diameter of the opening (1012) is greater than a width of the recess or the cut-out (1010).
